(19) United States
(12) Patent Application Publication
(10) Pub. No.: US 2013/0176961 A1
(43) Pub. Date: Jul. 11, 2013

(54) APPARATUS AND METHODS OF UNAMBIGUOUS MAC-I PDU FORMATTING

(71) Applicant: QUALCOMM Incorporated, San Diego, CA (US)

(72) Inventors: Sitaramanjaneyulu Kanamarlapudi, San Diego, CA (US); Liangchi Hsu, San Diego, CA (US); Yongsheng Shi, San Diego, CA (US); Rohit Kapoor, San Diego, CA (US); Ravi Agarwal, San Diego, CA (US); Siddharth Mohan, San Diego, CA (US); Sharad Deepak Sambhwani, San Diego, CA (US); Yi Zhang, San Diego, CA (US)

(73) Assignee: QUALCOMM Incorporated, San Diego, CA (US)

(21) Appl. No.: 13/736,567

(22) Filed: Jan. 8, 2013

Related U.S. Application Data
(60) Provisional application No. 61/584,751, filed on Jan. 9, 2012.

(51) Int. Cl. H04W 72/04

(52) U.S. Cl. CPC H04W 72/04
USPC 370/329

(57) ABSTRACT

The described aspects include a user equipment (UE) apparatus and corresponding method of performing a High-Speed Uplink Packet Access (HSUPA) transmission. The aspects include determining availability of information for transmission while the UE is in a Cell_FACH state and an idle mode. Further, aspects include generating a message including a scheduling information (SI) indicator during a collision resolution phase of an uplink procedure when SI data is allowed to be transmitted during the collision resolution phase, wherein the SI indicator identifies whether the SI data is included in a Medium Access Control-i (MAC-i) Packet Data Unit (PDU). Additionally, the aspects include transmitting the message, destined for a network component, during the collision resolution phase. The described aspects also include a corresponding network component and method for receiving the message and unambiguously determining presence of SI data in the MAC-i PDU.

### CLAIM OF PRIORITY UNDER 35 U.S.C. §119

The present application for Patent claims priority to Provisional Application No. 61/584,751 entitled “Apparatus and Methods of Unambiguous Mac-I PDU Formatting” filed Jan. 9, 2012, and assigned to the assignee hereof and hereby expressly incorporated by reference herein.

### BACKGROUND

1. Field

Aspects of the present disclosure relate generally to wireless communication systems, and more particularly, to apparatus and methods of unambiguous Medium Access Control-i (MAC-i) Packet Data Unit (PDU) formatting when performing an enhanced uplink in Cell_FACH procedure.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

One such improvement in 3GPP Release 8 relates to enhancing uplink transmissions by using a fast Enhanced Dedicated Transport Channel (E-DCH). Specifically, prior to Release 8, a user equipment (UE) not in the Cell-DCH state, i.e. not observing and receiving data over the High Speed Shared Channels, was instead in the less power consuming Cell_FACH, Cell_PCH or URA_PCH states, where uplink packets were sent over the Random Access Channel (RACH). The RACH was limited in data rate and capacity. So, for example, a UE in the Cell_FACH state with a large amount of data to send would either need to make multiple random access channel attempts, or transition from the Cell_FACH state to a Cell_DCH state in order to transmit on a high-speed Dedicated Channel (DCH). Accordingly, instead of using the RACH, Release 8 specified the enhanced uplink in Cell_FACH procedure for uplink transmissions, including configuring the E-DCH with default values, e.g. a modulation and coding scheme that is conservative enough so even UEs at the edge of a cell can use it.

One problem with the enhanced uplink in Cell_FACH procedure, however, relates to ambiguity in the network being able to differentiate different Medium Access Control (MAC) Packet Data Unit (PDU) formats transmitted by the UE. Specifically, there are two different MAC PDU formats for E-DCH transmission. Depending on configuration by upper layers the format is either MAC-e/es or MAC-i/is. The MAC PDU format is determined by upper layer signalling. MAC-i is used in Cell_FACH mode, and when there is sufficient space left in the E-DCH transport block or if Scheduling Information (SI) needs to be transmitted, SI data will be included at the end of the MAC-i PDU. Also, for Frequency Division Duplex (FDD) and in CELL_FACH state only, an E-DCH Radio Network Temporary Identifier (E-RNTI) of the UE can be included in the MAC-i header for collision resolution purposes. The inclusion of the E-RNTI is signaled with a reserved Logical Channel Identifier (LCH-ID) value, which may serve to identify a logical channel associated with the contents of the MAC PDU at a receiver, such as, but not limited to, a network component.

As per the current 3GPP MAC specification version (e.g. 3GPP TS 25.321, Release 8 and onwards), when a MAC-i PDU is configured during a collision resolution phase, a MAC-i header 0, e.g. an initial MAC-i header, would be the first part of the MAC-i PDU. Then, either a MAC-i header 1, e.g. a next-in-sequence MAC-i header, or an SI will immediately follow. In this case, however, the network cannot distinguish between the MAC-i header 1 and the SI as there is no distinctive pattern to identify them unambiguously. Thus, the UE does not have a reliable mechanism for communicating system information to the network, which can thereby reduce system performance.

Some prior solutions to avoid the ambiguity problem include not sending SI data during the collision resolution phase when a total amount of data available across all logical channels for which reporting has been requested is not equal to zero, e.g. when a value of a Total E-DCH Buffer Status (TEBS) field is not equal to zero. This solution, however, results in a lack of the network receiving SI data, thereby reducing the ability of the network to enhance system performance.

Therefore, improvements in the enhanced uplink in Cell_FACH procedure are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method of a user equipment (UE) performing a High-Speed Uplink Packet Access (HSUPA) transmission includes determining availability of information for transmission while the UE is in a Cell_FACH state and an idle mode. Further, the method includes generating a message including a scheduling information (SI) indicator during a collision resolution phase of an uplink procedure when SI data is allowed to be transmitted during the collision resolution phase, wherein the SI indicator identifies whether the SI data is included in a Medium Access Control-i (MAC-i) Packet Data Unit (PDU). Additionally, the method includes transmitting the message, destined for a network component, during the collision resolution phase.

Other aspects include one or more of: a computer program product having a computer-readable medium including at least one instruction operable to cause a computer to perform the above-described method; an apparatus including one or more means for performing the above-described method; and an apparatus having a memory in communication with a processor that is configured to perform the above-described method. Additionally, the described aspects also include a corresponding network component apparatus, computer program product and method for receiving the message and unambiguously determining presence of SI data in the MAC-i PDU.

These and other aspects of the disclosure will become more fully understood upon a review of the detailed description, which follows.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic block diagram of one aspect of a system for achieving unambiguous decoding of SI data during collision resolution phase of an enhanced uplink Cell_FACH procedure;

FIG. 2 is a message flow diagram of an enhanced uplink Cell_FACH procedure described herein;

FIG. 3 is a schematic block diagram of exemplary components of the UE of FIG. 1;

FIG. 4 is a schematic block diagram of exemplary components of the network component of FIG. 1;

FIG. 5 is a flowchart of one aspect of a method for generating and transmitting a message including an SI indicator of the system of FIG. 1;

FIG. 6 is a flowchart of one aspect of a method for receiving a MAC-i PDU and determining whether the MAC-i PDU includes SI data of the system of FIG. 1;

FIG. 7 is a block diagram of an example logical grouping of the electrical components of the UE of FIG. 1;

FIG. 8 is a block diagram of an example logical grouping of electrical components of the network component of FIG. 1;

FIG. 9 is a block diagram illustrating an example of a hardware implementation for an apparatus of FIG.;

FIG. 10 is a block diagram conceptually illustrating an example of a telecommunications system including aspects of the system of FIG. 1;

FIG. 11 is a conceptual diagram illustrating an example of an access network including aspects of the system of FIG. 1;

FIG. 12 is a conceptual diagram illustrating an example of a radio protocol architecture for the user and control plane implemented by components of the system of FIG. 1; and

FIG. 13 is a block diagram conceptually illustrating an example of a Node B in communication with a UE in a telecommunications system, including aspects of the system of FIG. 1.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The apparatus and methods described herein enable a network component to identify which data element is immediately following a MAC-i header 0 (note that “header” may be abbreviated as “hdr” in this document). According to the current standard, one cannot differentiate if the next data element is an SI or a MAC-i header 1. In some non-limiting examples, the MAC-i header may be one or more bits that may be appended to a MAC-i PDU to indicate the contents of the MAC-I PDU. Specifically, according to the current standard, the possible combinations are: (i) Mac-i hdr0+SI+padding; (ii) MAC-i hdr0+MAC-i hdr1+data+SI+padding; and (iii) MAC-i hdr0+MAC-i hdr1+data+padding. In one aspect, the present apparatus and methods enable network component to distinguish (i) as compared to (ii) or (iii), e.g. whether or not the SI data follows MAC-i hdr0. In another aspect, depending on whether adding SI data is mandatory when enough space is available, the present apparatus and methods enable network component to distinguish (ii) and (iii), e.g. whether or not the SI data is included, such as after the MAC-i hdr1 and before the padding. In other words, the aspects described herein utilize a message and SI indicator and/or an operation mode to indicate (i) if SI data is immediately following MAC-i hdr0, and/or (ii) if SI data is included (if SI is not mandatory). Thus, the described aspects enable unambiguous MAC-i formatting with respect to SI data.

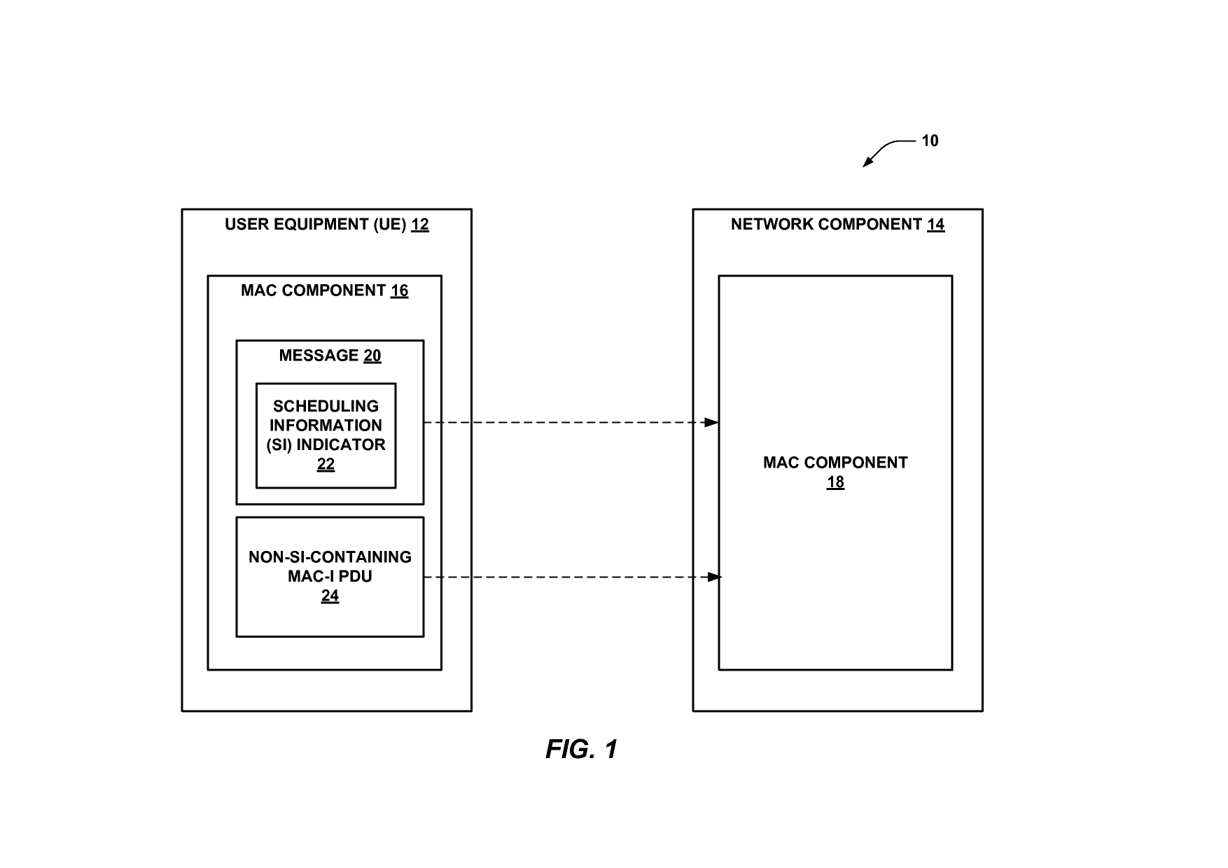

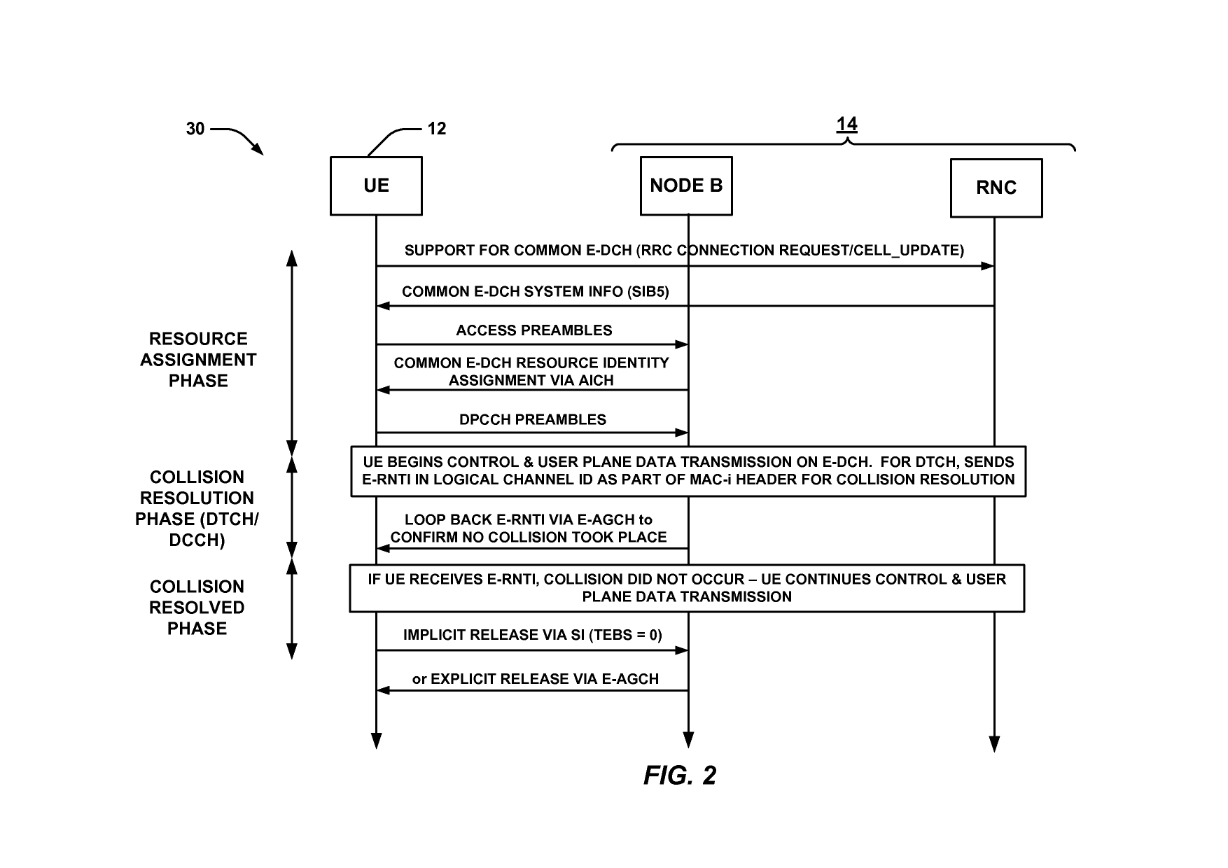

Referring to FIGS. 1 and 2, in one aspect, a wireless communication system 10 includes a user equipment (UE) 12 in communication with a network component 14, such as a Node B and/or Radio Network Controller (RNC). UE 12 includes a Medium Access Control (MAC) component 16 configured to communicate with a corresponding MAC component 18 in network component 14 in order to resolve Packet Data Unit (PDU) formatting ambiguities during a collision resolution phase of an enhanced uplink in Cell Forward Access Channel (Cell_FACH) procedure 30 (FIG. 2) performed with network component 14. Specifically, MAC component 16 and MAC component 18 are configured to address ambiguities in differentiating MAC-i PDU formats that are present in prior art systems, and that cause prior art network components difficulties in being able to identify whether or not a MAC-i PDU transmitted by a UE includes scheduling information (SI) data. In particular, according to system 10, MAC component 16 and MAC component 18 are configured to operate in different operational modes where either the presence of the SI data in a MAC-i PDU is signaled via an indicator or where the mode expressly prohibits the transmission of the SI data during the collision resolution phase. Further, for example, the indicator or mode may identify whether SI data is present or not in a MAC-i PDU, and/or how the SI data is included in a MAC-i PDU. In particular, with regard to how the SI data is included, e.g. the SI indicator may identify where in the MAC-i PDU the SI data may be found, or a position of the SI data.

For example, in one optional aspect of one or more operational modes, MAC component 16 generates a message 20 that includes an (SI) indicator 22 that identifies whether or not SI data is included in a MAC-i PDU, and/or how the SI data is included in the MAC-i PDU. In this aspect, message 20 may be a MAC-i PDU with SI data or a non-SI-containing MAC-i PDU, or message 20 may be a different type of message, e.g. not a MAC-i PDU, that signals whether the SI data is present in a corresponding MAC-i PDU. Further, for example, in another optional aspect in the operational mode that expressly prohibits the transmission of the SI data during the collision resolution phase, MAC component 16 is only allowed to generate a non-SI-containing MAC-i PDU 24, e.g. a MAC-i PDU without SI data.

Correspondingly, MAC component 18 is configured to receive message 20 or non-SI-containing MAC-i PDU 24 transmitted by UE 12 during the collision resolution phase. Further, in one aspect, MAC component 18 is configured to interpret SI indicator 22 in order to determine whether or not SI data is included in a corresponding MAC-i PDU. As such, MAC component 18 is configured to obtain the SI data in the MAC-i PDU when a value of SI indicator 22 represents the presence of the SI data. In this case, network component 14 can then utilize the SI data when making scheduling decisions with respect to UE 12. Otherwise, when a value of SI indicator 22 represents that SI data is not present, MAC component 18 is configured to treat the data in the MAC-i PDU to be non-SI data. In another aspect, MAC component 18 is configured to know the operating mode associated with transmissions from UE 12. As such, MAC component 18 is configured to either monitor or not monitor for SI indicator 22. Further, based on a known operating mode where SI data is prohibited, MAC component 18 is configured to recognize that a MAC-i PDU sent during the collision resolution phase, such as non-SI-containing MAC-i PDU 24 transmitted during the prohibited mode, cannot contain SI data. As such, in this case, MAC component 18 is certain that the received MAC-i PDU does not include SI data.

Thus, in system 10, UE 12 and network component 14 are configured with respective MAC components 16 and 18 configured to operate in one or more modes that based on the mode or an explicit indicator used in the mode, are able identify whether and/or how SI data is present in a MAC-i PDU during the conflict resolution phase. Therefore, system 10 resolves MAC-i PDU formatting ambiguities that have plagued prior art systems during the collision resolution phase of an enhanced uplink in Cell Forward Access Channel (Cell_FACH) procedure, allowing network component 14 to reliably obtain SI data from UE 12 and thereby increase the potential for improving scheduling performance of the network.

The different operational modes of MAC component 16 and MAC component 18 may be defined as an “SI inclusion mode” having different sub-modes. In a first sub-mode, referred to as a “mandatory” sub-mode, MAC component 16 adds the SI data when the MAC-i PDU has space for the SI data. In a second sub-mode, referred to as an “optional” or “not mandatory” sub-mode, even though the MAC-i PDU is determined to have space available, MAC component 16 may or may not add the SI data to the MAC-i PDU. For example, in the second sub-mode, the option to add or not add the SI data may be resolved according to a preference of an operator of system 10 or a manufacturer or controller of some system component. In a third sub-mode, referred to as “prohibited” sub-mode, MAC component 16 is absolutely not allowed to add the SI data to the MAC-i PDU. MAC component 16 and MAC component 18, which may be corresponding MAC-i entities associated with protocol layers of UE 12 and network component 14, respectively, may communicate with each other to agree on a particular sub-mode of the SI inclusion mode, or may be pre-set to work on a particular sub-mode, or may operate according to a protocol that dictates which sub-mode should be used.

MAC component 16, when operating in the “mandatory” sub-mode or in the “optional”/“not mandatory” sub-mode, determines available space in a MAC-i PDU based on an Enhanced Transport Format Combinations (E-TFC) selection procedure. In the E-TFC procedure, a determined number of bits that can be sent in a MAC-i PDU, referred to as a Transport Block (TB), may be based on one or more factors, such as but not limited to one or more of a network grant, power headroom, or how much data is available to be sent. In one non-limiting case, for example, when a MAC-i PDU is configured, if the size of the data, e.g. MAC-is PDUs, plus header(s) is less than or equal to the Transport Block (TB) size selected by the UE minus 18 bits, then an SI element including the SI data shall be concatenated into the MAC-i PDU. Otherwise an SI element including the SI data is not included in the MAC-i PDU. For instance, in an example that should not be construed as limiting, after E-TFC selection, a TB size is determined, say it is 120 bits (refer to Annex B in 3GPP TS 25.321 to see possible TB sizes). Assuming MAC-i header 0+MAC-i header 1+PDU is 100 bits, then 20 bits are remaining. If the SI inclusion operating sub-mode is “mandatory,” then MAC component 16 adds an SI element including SI data (18 bits) and a padding element (2 bits) to make the length of the MAC-i PDU 120 bits. If the SI inclusion operating sub-mode is “not mandatory”/“optional,” then MAC component 16 has two choices: one is the same as above; the other is to add a padding element of 20 bits in order to bring the length of the MAC-i PDU up to 120 bits. Alternatively, when the SI inclusion operating sub-mode is “prohibited,” MAC component 16 does not need to determine if space is available for the SI data.

Additionally, message 20 with SI indicator 22 may include a MAC-i PDU transmitted on an E-DCH transport channel, otherwise referred to as an E-DCH Dedicated Physical Data Control Channel (E-DPDCH), or a control information message transmitted on E-DPCCH. Further, message 20 with SI indicator 22 may include one or more of a plurality of types of messages and/or indicators. For example, one or more types of message 20 with SI indicator 22 may be defined by a new MAC-i PDU header format, such as a format not currently defined in the 3GPP TS 25.321 specification. Alternatively or additionally, one or more types of message 20 with SI indicator 22 may be defined by an existing MAC-i header having modified or re-purposed contents, such as, but not limited to, MAC-i header 0 and/or MAC-i header 1 spare bits and/or length bits, and/or skipping the E-DCH Radio Network Temporary Identifier (E-RNTI) bits. Furthermore, one or more types of message 20 with SI indicator 22 may be alternatively or additionally defined by a control information message carried on the E-DCH Dedicated Physical Control Channel (E-DPCCH) having modified or re-purposed contents, such as, but not limited to, reserving one bit of the E-DCH Transport Format Combination Identifier (E-TFCI), which is an element that includes information about the transport block (TB) set size, for indicating SI data.

Accordingly, in an aspect, when the SI inclusion sub-mode is the “mandatory” sub-mode, MAC-i PDU format encoding may include one or more of the following cases. First (i.e. “case 1”), if SI transmission is mandatory when there is enough space, a MAC-i hdr0 with spare bits having a first value, such as 0000, indicates MAC-i hdr1 immediately follows MAC-i hdr0. For example, this format may include, but is not limited to:

MAC-i hdr0 with spare bits 0000+MAC-i hdr1+PDU+Optional SI (based on available number of bits)+optional padding

Further, a MAC-I hdr0 with spare bits having a different, second value, such as 0001, indicates SI data immediately follows MAC-i hdr0. For example, this format may include but is not limited to:

MAC-i hdr0 with spare bits 0001+SI+optional padding

Next (i.e. “case 2”), the encoding may include an additional MAC-i hdr0 to indicate presence of SI information. For example, after the first MAC-i hdr0, if there is another MAC-i hdr0, an SI will immediately follow. In this case, the lack of SI data is signaled by a format such as but not limited to:

MAC-i hdr0+MAC-i hdr1+PDU+optional SI+optional padding

Further, in this case 2, the inclusion of SI data is signaled by a format such as but not limited to:

MAC-i hdr0+MAC-i hdr0+SI+optional padding

In another case (i.e. “case 3”), an additional stripped version of a MAC-i hdr0 may be used to indicate presence of SI information. For example, MAC-i hdr0 alone indicates no presence of SI information. After the first MAC-i hdr0, however, if there is stripped version of a MAC-i hdr0, such as a MAC-i hdr0 without E-RNTI, then an SI can immediately follow. In this case, the lack of SI data is signaled by a format such as, but not limited to:

MAC-i hdr0+MAC-i hdr1+PDU+optional SI+optional padding

Further, in this case, the inclusion of SI data is signaled by a format such as but not limited to:

MAC-i hdr0+MAC-i hdr0 (without ERNTI info)+SI+optional padding

In an additional or alternative case (i.e. “case 4”), a MAC-i hdr1 with Length Indicator may have a designated value, such as 0, to indicate SI information immediately follows. In this case, the lack of SI data may be signaled by a format such as, but not limited to:

MAC-i hdr0+MAC-i hdr1+PDU+optional SI+optional padding

Further, in this case, the inclusion of SI data is signaled by a format such as but not limited to:

MAC-i hdr0+MAC-i hdr1 (with Length Indicator as all 0s)+SI+optional padding

In a further case (i.e. “case 5”), the encoding may include additional special MAC-i hdr information to indicate presence of SI information. Such special MAC-i hdr information may include, but is not limited to, a special SI element format having a special value or bit configuration, which, in some non-limiting examples, may include a LCH-ID associated with a MAC-i PDU and spare bits to indicate the presence of SI information. In some non-limiting examples, this MAC-i hdr may have a structure containing eight bits, such as, but not limited to:

Special MAC-i hdr for SI=LCH-ID+Spare bits as 0001=4+4=8 bits.

In this case, the lack of SI data is signaled by a format such as, but not limited to:

MAC-i hdr0+MAC-i hdr1+PDU+optional SI+optional padding

Further, in this case, the inclusion of SI data is signaled by a format such as, but not limited to:

MAC-i hdr0+special MAC-i hdr for SI+SI

It should be noted that above cases 2-5 may also be characterized or defined as formats that include a special header after MAC-i header 0.

In an additional or alternative case, (i.e. “case 6”), E-DPCCH information can be modified, for example, such that two different values of one bit can be used to signal presence or lack of presence of SI data. It is noted that E-DPCCH contains a 2-bit RNS, a 7-bit E-TFCI, and a 1-bit Happy bit. During the collision resolution phase, the E-TFCI may be assumed to be low. Thus, in one aspect, the modification may include, but is not limited to, re-purposing one of the 7 bits of the E-TFCI to indicate if SI exists or not.

Additionally or alternatively, in one aspect when the SI inclusion sub-mode is the “not mandatory”/“optional” sub-mode, then MAC-i PDU format encoding may include the following case (i.e. “case 7”). According to case 7, if SI transmission is not mandatory, but is optionally allowed, to avoid ambiguity, modifying existing headers or utilizing special headers, or both, may be utilized to indicate various states. For example, these configurations may identify when no SI data is present, or when SI data is present, or when SI data is present and a relative location of the SI data within the MAC-i PDU. For instance, in this case, the absence of SI data is signaled by a format such as, but not limited to:

MAC-i hdr0 with spare bits as 0000+MAC-i hdr1+PDU+No SI+optional padding

Further, in this case, the inclusion of SI data following a MAC-i header 1 may be signaled by a format such as but not limited to:

MAC-i hdr0 with spare bits as 0001+MAC-i hdr1+PDU+SI+optional padding

Additionally, in this case, the inclusion of SI data following a MAC-i header 0 may be signaled by a format such as but not limited to:

MAC-i hdr0 with spare bits as 0010+SI+optional padding

The above case 7 for the “not mandatory” sub-mode corresponds with case 1 of the “mandatory” sub-mode. It should be noted that additional similar configurations may be utilized for cases 2-5, such as where 3 different configurations are utilized to indicate when no SI data is present, or when SI data is present and/or points to a relative location of the SI data within the MAC-i PDU.

In a further case (i.e. “case 8”), E-DPCCH information can be modified, for example, such that two different values of one bit can be used to signal presence or lack of presence of SI data. It is noted that E-DPCCH contains a 2-bit RNS, a 7-bit E-TFCI, and a 1-bit Happy bit. During the collision resolution phase, the E-TFCI is assumed to be low, and so, in one aspect, the modification may include but is not limited to re-purposing one of the 7 bits of the E-TFCI to indicate if SI exists or not.

The above case 8 for the “not mandatory” sub-mode may, in some examples, roughly correspond with case 6 of the “mandatory” sub-mode. Moreover, in one aspect when the SI inclusion sub-mode is the “prohibited” sub-mode, then MAC-i PDU format encoding may do not change, but the MAC-i entities operate according to an alternative or additional “case 9,” where SI data is not sent during the collision resolution phase. Thus, system 10 may utilize any of cases 1-9, thereby achieving unambiguous decoding of the SI data during collision resolution phase, and specifically identifying whether SI data is present or not, and how the SI data is included in a MAC-i PDU.

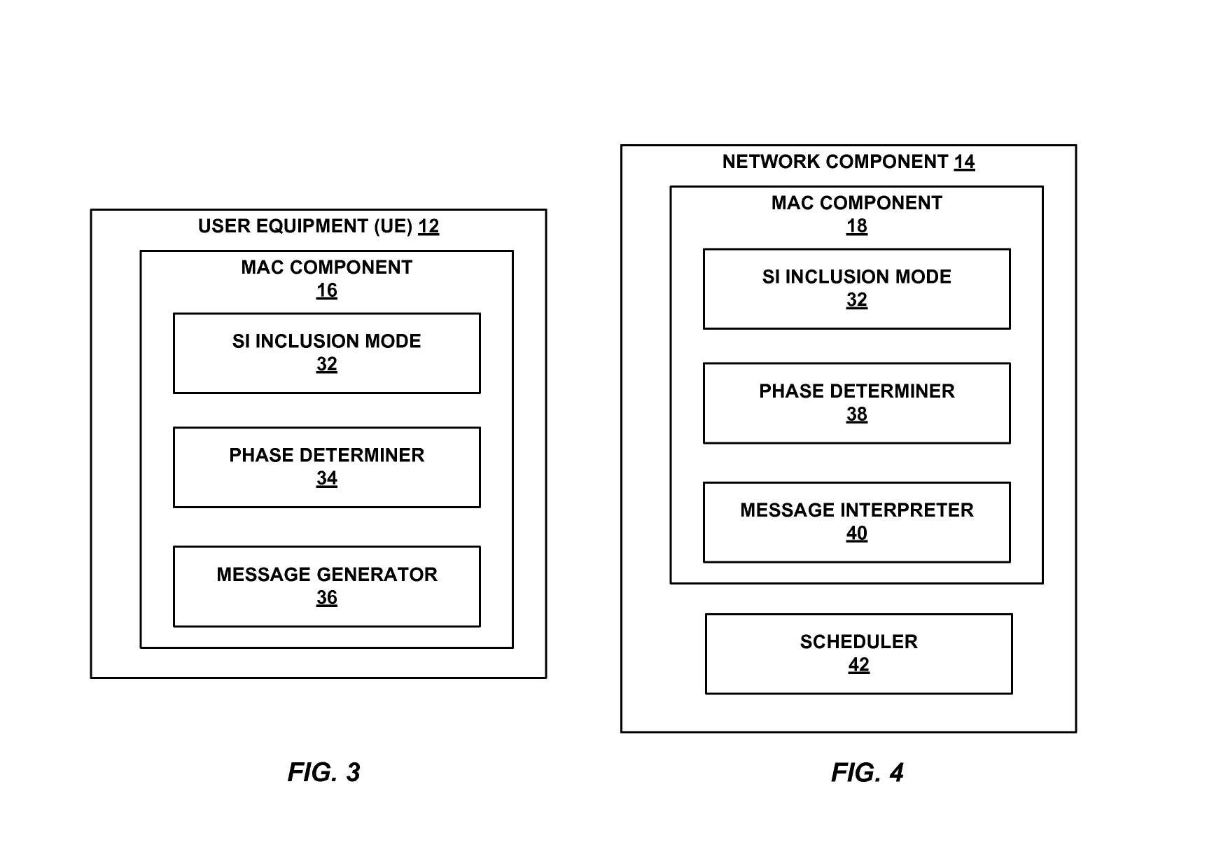

Referring to FIG. 3, in one aspect, UE 12 and/or MAC component 16 may include one or more components for performing the functionality described herein. For example, UE 12 and/or MAC component 16 may include any combination of specially programmed hardware, specially programmed software or code or computer-readable instructions, specially programmed firmware, etc. This hardware and/or software may be used, in conjunction with memory, for example, to implement phase determiner and message generator 36.

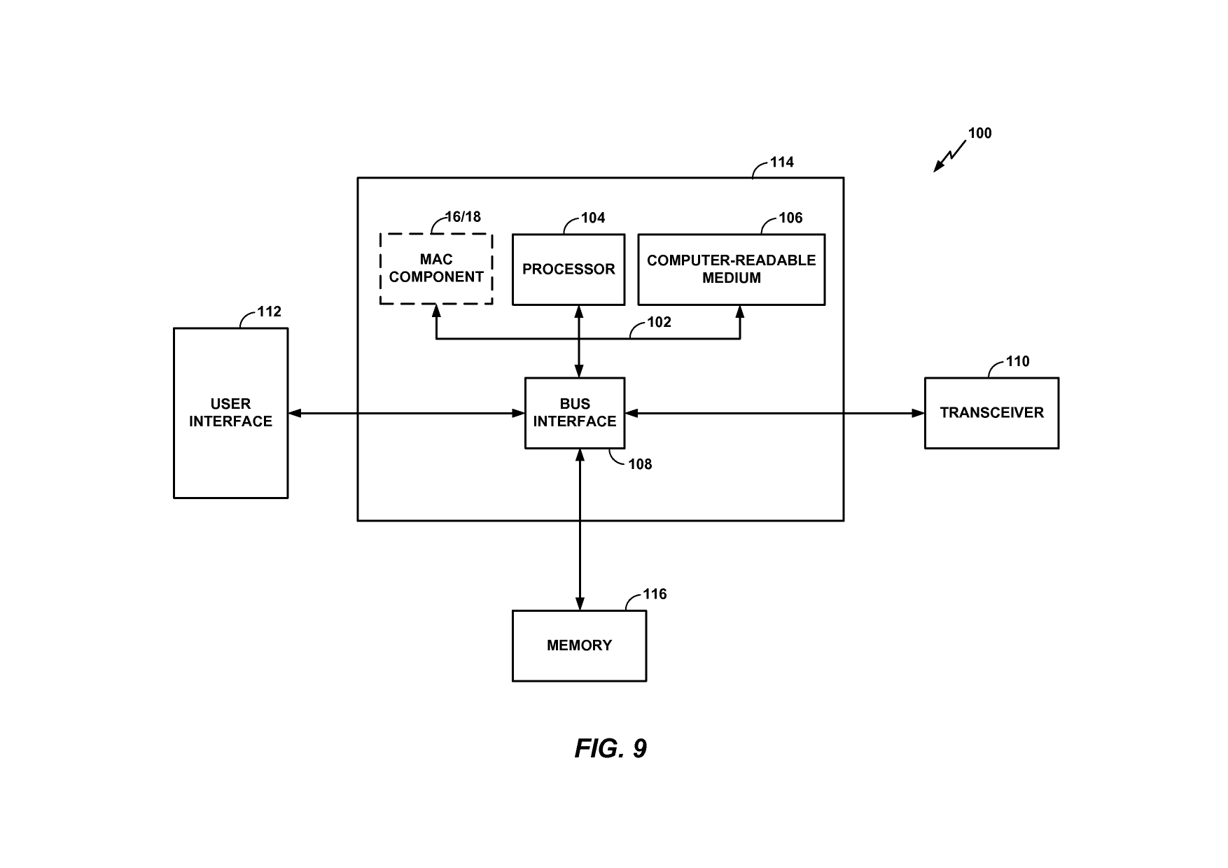

In an additional aspect, UE 12 and/or MAC component 16 may operate according to one or more SI inclusion modes 32, which may include one or more submodes, such as, but not limited to, “mandatory” or “not mandatory”/“optional.” As described above, each of the one or more SI inclusion modes 32 may direct MAC component 16 and/or 18 to include, not include, or optionally include SI data in one or more MAC-i PDUs according. In a further aspect, the SI inclusion modes 32 may have one or more corresponding encoding cases, as described above, each of which may have an associated bit format for one or more of a MAC-i PDU header and the MAC-i PDU itself. Further, the one or more SI inclusion modes 32 may be stored in memory, such as, but not limited to memory 116 of FIG. 9. It should be noted that SI inclusion mode 32 may not be an explicitly stored mode or value, but instead may be a function of a protocol or procedure implemented by UE 12 and/or MAC component 16.

Further, in an optional aspect, UE 12 and/or MAC component 16 may include a phase determiner 34 configured to determine a phase of an enhanced uplink Cell_FACH procedure (FIG. 2). For example, phase determiner 34 may monitor messages exchanged with network component 14, thereby enabling phase determiner 34 to identify a given phase, such as the collision resolution phase. In some aspects. phase determiner 34 may be implemented by processor 104 of FIG. 9.

Additionally, in an aspect, UE 12 and/or MAC component 16 may include a message generator 36 for generating one or more messages associated with an enhanced uplink Cell_FACH procedure (FIG. 2), as described above. For example, message generator 36 may generate one or more different types of messages, including but not limited to one or more of MAC-i PDUs including MAC-i PDU having SI data and MAC-i PDUs without SI data, MAC-i PDU having an SI indicator, MAC-i PDUs including modified contents to signal presence of SI data, MAC-i PDUs including special headers or other special formatting to signal presence of SI data, control information messages including E-DCH Dedicated Physical Control Channel (E-DPCCH) control information messages having a particular bit to represent the SI indicator, message 20 (FIG. 1), or non-SI-containing MAC-i PDU 24 (FIG. 1). In an aspect, this particular bit may be a repurposed bit, such as a bit that may have previously been reserved, for example, in a previous wireless specification (e.g. 3GPP or 3GPP2 specification), to represent a particular parameter value, state, or other value, but can be used according to the present disclosure to represent a different value, such as, but not limited to the SI indicator, message 20 (FIG. 1), or non-SI-containing MAC-i PDU 24 (FIG. 1). Additionally, message generator 36 may communicate with or be aware of a state of phase determiner 34 and/or SI inclusion mode 32 and/or network component 14 in order to generate a given message, as described above. Furthermore, message generator 36 may be implemented by processor 104 of FIG. 9.

Referring to FIG. 4, in one aspect, network component 14 and/or MAC component 18 may include one or more components for performing the functionality described herein. For example, network component 14 and/or MAC component 18 may include any combination of specially programmed hardware, specially programmed software or code or computer-readable instructions, specially programmed firmware, etc. This hardware and/or software may be used, in conjunction with memory, for example, to implement a phase determiner 38 a message interpreter 40 and a scheduler 42.

In an aspect, network component 14 and/or MAC component 18 may operate according to one or more SI inclusion modes 32, which may include one or more submodes, such as, but not limited to, “mandatory” or “not mandatory”/“optional.” As described above, each of the one or more SI inclusion modes 32 may direct MAC component 18 to include, not include, or optionally include SI data in one or more MAC-i PDUs according. In a further aspect, the SI inclusion modes 32 may have one or more corresponding encoding cases, as described above, each of which may have an associated bit format for one or more of a MAC-i PDU header and the MAC-i PDU itself. Further, the one or more SI inclusion modes 32 may be stored in memory, such as, but not limited to memory 116 of FIG. 9. It should be noted that SI inclusion mode 32 may not be an explicitly stored mode or value, but instead may be a function of a protocol or procedure implemented by network component 14 and/or MAC component 18.

Further, in an optional aspect, network component 14 and/or MAC component 18 may include a phase determiner 38 configured to determine a phase of an enhanced uplink Cell_FACH procedure (FIG. 2). For example, phase determiner 38 may monitor messages exchanged with UE 12, thereby enabling phase determiner 38 to identify a given phase, such as the collision resolution phase. In an aspect, phase determiner 38 may be implemented by processor 104 of FIG. 9.

Additionally, in an aspect, network component 14 and/or MAC component 18 may include a message interpreter 40 for interpreting whether or not one or more messages associated with an enhanced uplink Cell_FACH procedure (FIG. 2) in order to identify when a corresponding received MAC-i PDU includes SI data, as described above. For example, message interpreter 40 may be configured to recognize and interpret one or more different types of messages, including but not limited to one or more of MAC-i PDUs including MAC-i PDU having SI data and MAC-i PDUs without SI data, MAC-i PDU having an SI indicator, MAC-i PDUs including modified contents to signal presence of SI data, MAC-i PDUs including special formatting, such as, but not limited to, special headers, to signal presence of SI data, control information messages including E-DCH Dedicated Physical Control Channel (E-DPCCH) control information messages having a particular re-purposed bit to represent the SI indicator, message 20 (FIG. 1), or non-SI-containing MAC-i PDU 24 (FIG. 1). In an aspect, message interpreter 40 may be implemented by processor 104 of FIG. 9.

Additionally, message interpreter 40 may communicate with or be aware of a state of phase determiner 38 and/or SI inclusion mode 32 and/or UE 12 in order to interpret a given message and determine if a MAC-i PDU includes SI data, as described above. Optionally, network component 14 and/or MAC component 18 may include a scheduler 42 configured to obtain the SI data and make scheduling decisions, such as downlink transmission grants, etc., for UE 12 and/or other UEs relative to UE 12 based on the SI data. In an aspect, scheduler 42 may be implemented by processor 104 of FIG. 9.

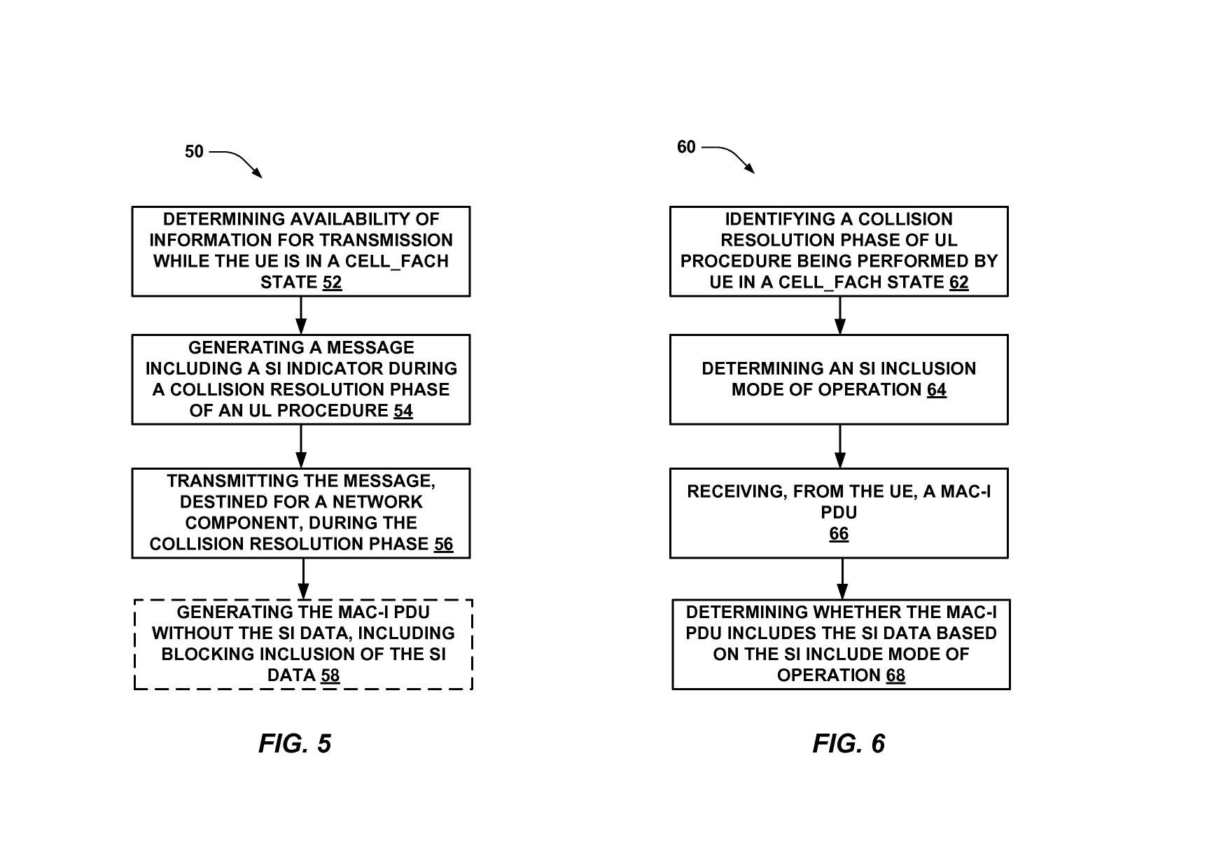

FIG. 5 illustrates an exemplary method 50 for performing HSUPA transmission of one or more MAC-i PDUs that may indicate the presence, or lack thereof, of SI information in the MAC-i PDU or another MAC-i PDU. As shown, this method may include a MAC component (e.g. MAC component 16) determining availability of information for transmission while the UE is in a Cell_FACH state or in an idle mode (Block 52). In an aspect, when the UE is in such an “idle mode,” the UE may be powered on but may not be engaged in a call (e.g. data call, voice call, messaging, etc.). Further, method 50 includes a message generator (e.g. message generator 36 of FIG. 3) generating a message including a scheduling information (SI) indicator during a collision resolution phase of an uplink procedure when SI data is allowed to be transmitted during the collision resolution phase, wherein the SI indicator identifies whether the SI data is included in a Medium Access Control-i (MAC-i) Packet Data Unit (PDU) (Block 54). Additionally, method 50 includes a transmitter or transceiver (e.g. transceiver 110 of FIG. 9) transmitting the message to a network component (e.g. network component 14 of FIG. 1 or FIG. 4, during the collision resolution phase (Block 56). The transceiver (FIG. 9) may transmit this message either directly or indirectly to the network component.

Optionally, method 50 may further include the message generator generating the MAC-i PDU without the SI data, including blocking inclusion of the SI data, when the SI data is prohibited to be transmitted during the collision resolution phase (Block 58). Furthermore, in an aspect, method 50 may be performed by UE 12 and/or MAC component 16, as described above.

FIG. 6 illustrates an exemplary method 60 of a network component receiving a HSUPA transmission of one or more MAC-i PDUs from a UE, wherein the HSUPA transmission may indicate the presence, or lack thereof, of SI information in the MAC-i PDU or another MAC-i PDU. As illustrated, method 60 includes a MAC component (e.g. MAC component 18) identifying a collision resolution phase of an uplink procedure being performed by a user equipment (UE) in a Cell_FACH state and an idle mode when scheduling information (SI) data is allowed to be transmitted during the collision resolution phase (Block 62). Further, method 60 includes the MAC component determining an SI inclusion mode of operation (Block 64), and receiving, from the UE, a Medium Access Control-i (MAC-i) Packet Data Unit (PDU) (Block 66). Additionally, method 60 includes a message interpreter (e.g. message interpreter 40) determining whether the MAC-i PDU includes the SI data based on the SI inclusion mode of operation (Block 68). For example, method 60 may be performed by network component 14 and/or MAC component 18, as described above.

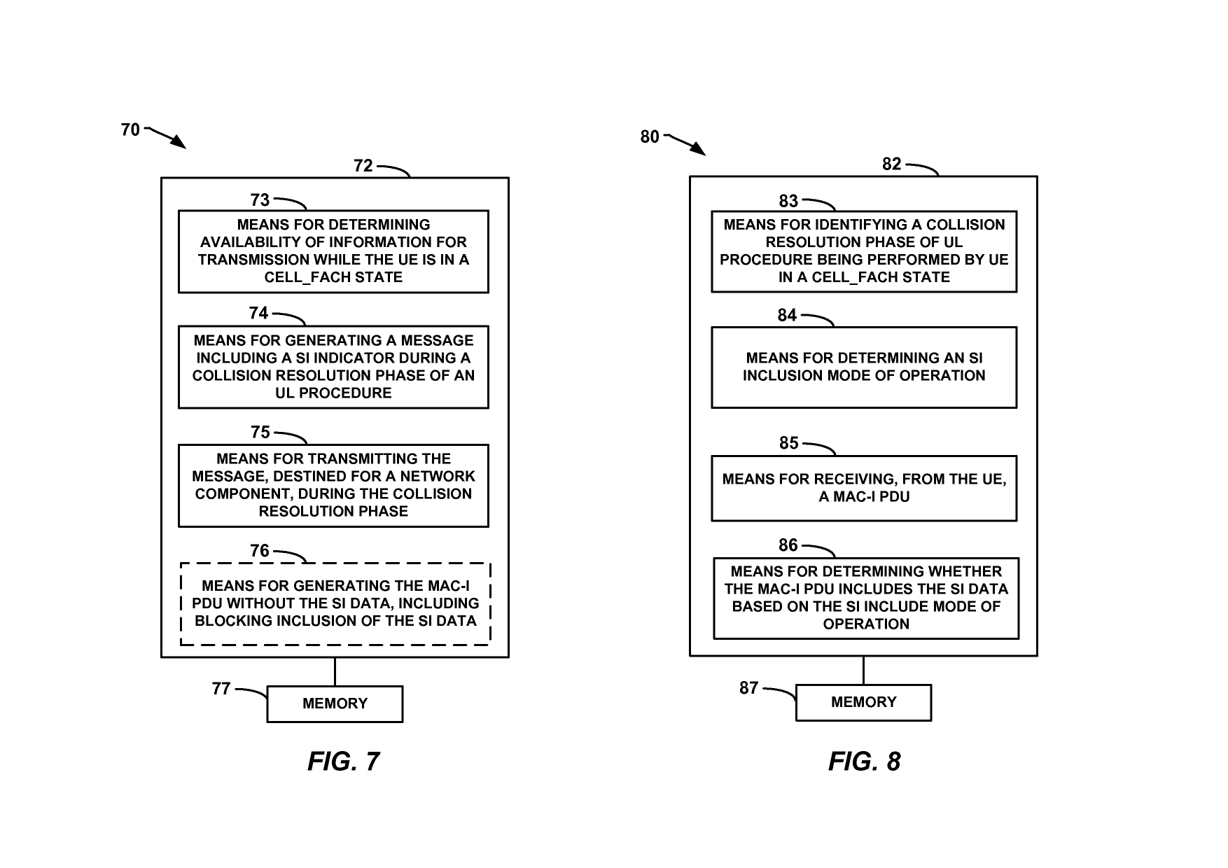

Referring to FIG. 7, an example system 70 is displayed for improved UE HSUPA transmission. For example, system 70 can reside at least partially within one or more UEs. It is to be appreciated that system 70 is represented as including functional blocks, which can be functional blocks that represent functions implemented by a processor, software, or combination thereof (e.g., firmware). System 70 includes a logical grouping 72 of electrical components that can act in conjunction. For instance, logical grouping 72 can include means for determining the availability of information for transmission while the UE is in a CELL_FACH state (Block 73). For example, in an aspect, the means 73 may include MAC component 16 (FIG. 3). Additionally, logical grouping 72 can include means for generating a message including an SI indicator during a collusion resolution phase of an uplink procedure (Block 74). For example, in an aspect, the means 74 may include message generator 36 (FIG. 3). In an additional aspect, logical grouping 72 can include means for transmitting the message, directly or indirectly, to a network component, during the collision resolution phase (Block 75). In an aspect, the means 75 may comprise transceiver 110 (FIG. 9, below). Furthermore, logical grouping 72 can optionally include means for generating the MAC-I PDU without the SI data, including blocking inclusion of the SI data (Block 76). In an aspect, the means 76 may comprise MAC component 16 and/or message generator 36 (FIG. 3).

Additionally, system 70 can include a memory 77 that retains instructions for executing functions associated with the electrical components 73, 74, 75, and 76, stores data used or obtained by the electrical components 73, 74, 75, and 76, etc. While shown as being external to memory 77, it is to be understood that one or more of the electrical components 73, 74, 75, and 76 can exist within memory 77. In one example, electrical components 73, 74, 75, and 76 can comprise at least one processor, or each electrical component 73, 74, 75, and 76 can be a corresponding module of at least one processor. Moreover, in an additional or alternative example, electrical components 73, 74, 75, and 76 can be a computer program product including a computer readable medium, where each electrical component 73, 74, 75, and 76 can be corresponding code.

Referring to FIG. 8, an example system 80 is displayed for improved network component HSUPA communication. For example, system 80 can reside at least partially within one or more network components. It is to be appreciated that system 80 is represented as including functional blocks, which can be functional blocks that represent functions implemented by a processor, software, or combination thereof (e.g., firmware). System 80 includes a logical grouping 82 of electrical components that can act in conjunction. For instance, logical grouping 82 can include means for identifying a collision resolution phase of an UL procedure being performed by a UE in a CELL_FACH state (Block 83). For example, in an aspect, the means 83 may include MAC component 18 (FIG. 3). Additionally, logical grouping 82 can include means for determining an SI inclusion mode of operation (Block 84). For example, in an aspect, the means 84 may include MAC component 18 and/or SI inclusion mode 32 (FIG. 3). In an additional aspect, logical grouping 82 can include means for receiving, from the UE, a MAC-i PDU (Block 85). In an aspect, the means 85 may comprise transceiver 110 (FIG. 9, below). Furthermore, logical grouping 82 can include means for determining whether the MAC-i PDU includes the SI data based on the SI include mode of operation (Block 86). In an aspect, the means 86 may comprise message interpreter 40 (FIG. 3).

Additionally, system 80 can include a memory 87 that retains instructions for executing functions associated with the electrical components 83, 84, 85, and 86, stores data used or obtained by the electrical components 83, 84, 85, and 86, etc. While shown as being external to memory 87, it is to be understood that one or more of the electrical components 83, 84, 85, and 86 can exist within memory 87. In one example, electrical components 83, 84, 85, and 86 can comprise at least one processor, or each electrical component 83, 84, 85, and 86 can be a corresponding module of at least one processor. Moreover, in an additional or alternative example, electrical components 83, 84, 85, and 86 can be a computer program product including a computer readable medium, where each electrical component 83, 84, 85, and 86 can be corresponding code.

FIG. 9 is a block diagram illustrating an example of a hardware implementation for an apparatus 100 employing a processing system 114. For example, apparatus 100 may be specially programmed or otherwise configured to operate as UE 12 and/or MAC component 16, and/or as network component 14 and/or MAC component 18, as described above. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106, and optionally MAC component 16 and/or 18. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a mechanism for communicating with various other apparatus over a transmission medium. Depending upon the nature of the apparatus, a user interface 112 (e.g., keypad, display, speaker, microphone, joystick) may also be provided. Furthermore, apparatus 100 may include a memory 116, such as for storing data used herein and/or local versions of applications being executed by processor 104. Memory 116 can include any type of memory usable by a computer, such as random access memory (RAM), read only memory (ROM), tapes, magnetic discs, optical discs, volatile memory, non-volatile memory, and any combination thereof. In some examples, memory 116 may be configured to store one of more SI inclusion modes (e.g. SI inclusion mode 32 of FIGS. 3 and 4).

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software. In an aspect, for example, processor 104 and/or computer-readable medium 106 may be specially programmed or otherwise configured to operate as UE 12 and/or MAC component 16, and/or as network component 14 and/or MAC component 18, as described above. In an aspect, processor 104 may be implemented by a microprocessor, central processing unit, or integrated circuit, such as, but not limited to an application-specific integrated circuit (ASIC), field-programmable gate array (FPGA), complex programmable logic device (CPLD), or any other type of processor configured to execute a set of instructions. Furthermore, computer-readable medium 106 may be a memory, such as, but not limited to, a volatile memory or non-volatile memory, a buffer, set of buffers, a cache, magnetic memory, solid-state memory, or any other type of electronic memory component or device that may store digital voltage values, bit values, instructions for execution by a MAC component (e.g. MAC component 16 and/or 18 of FIGS. 1-4) such as, but not limited to a MAC component implemented by processor 104.

The various concepts presented throughout this disclosure may be implemented across a broad variety of telecommunication systems, network architectures, and communication standards.

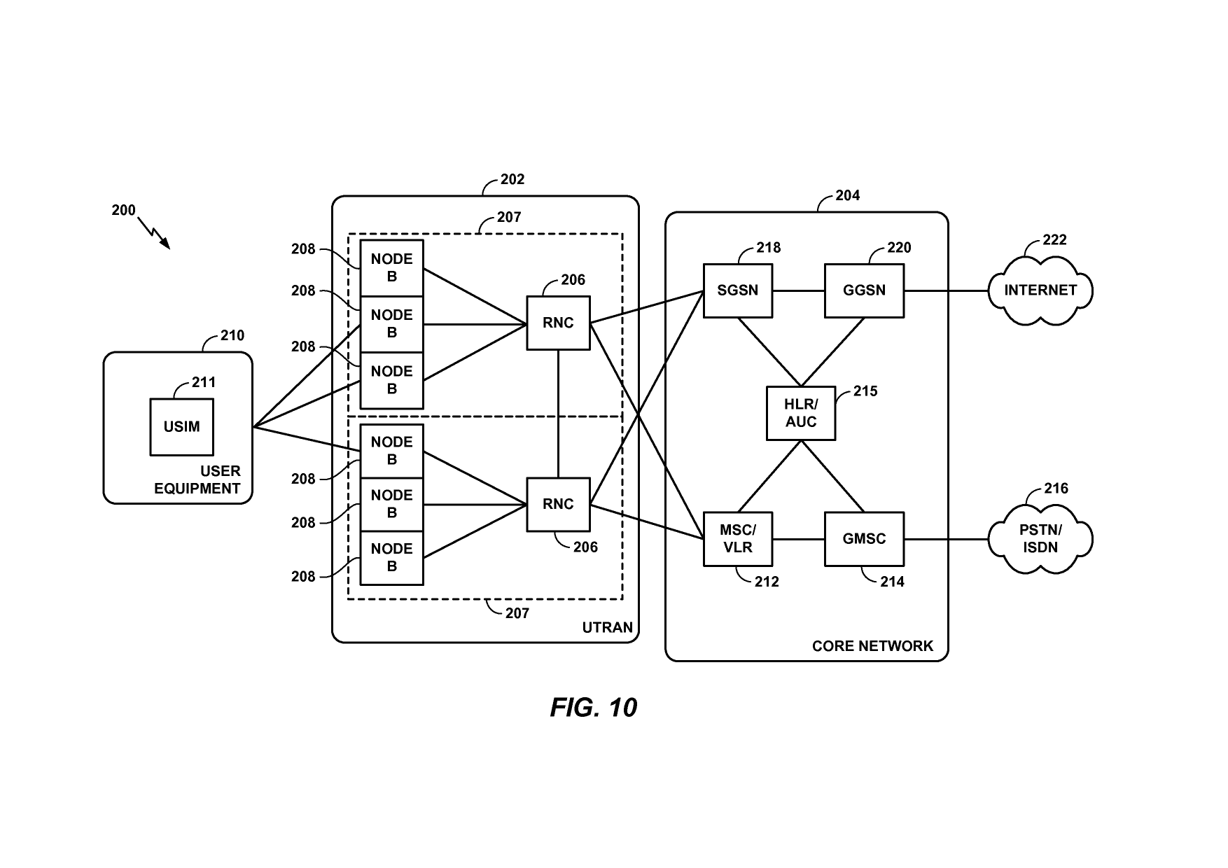

FIG. 10 illustrates an exemplary UMTS system 200 employing a W-CDMA air interface, which may employ HSPA. A UMTS network includes three interacting domains: a Core Network (CN) 204, a UMTS Terrestrial Radio Access Network (UTRAN) 202, and User Equipment (UE) 210. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v 9.1.0, incorporated herein by reference. Further, for example, UE 210 may be specially programmed or otherwise configured to operate as UE 12, and Node Bs 208 and/or RNCs 206 respectively may be specially programmed or otherwise configured to operate as network component 14, as described above.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of UEs (e.g. UE 12 of FIGS. 1-3), which may include one or more mobile apparatuses. Examples of a UE include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The UE may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams transmitted directly or indirectly to that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

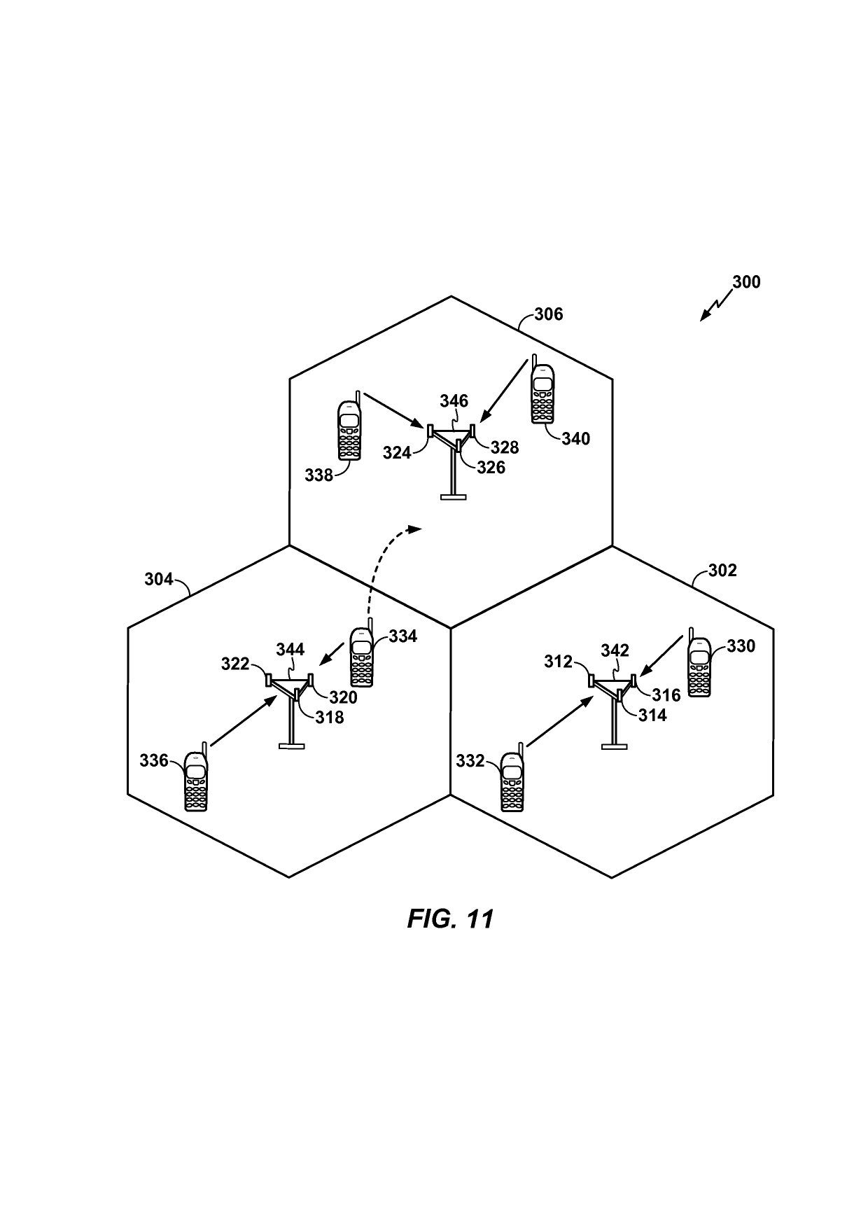

Referring to FIG. 11, an access network 300 in a UTRAN architecture is illustrated. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 2) for all the UEs 330, 332, 334, 336, 338, 340 in the respective cells 302, 304, and 306. For example, in an aspect, the UEs 330 and/or 332 of FIG. 11 may be specially programmed or otherwise configured to operate as UE 12 of FIGS. 1-3, and Node Bs 342, 344, and/or 346 may be specially programmed or otherwise configured to operate as network component 14 of FIGS. 1,2, and 4, as described above.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 2), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations, such as, but not limited to, UEs. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

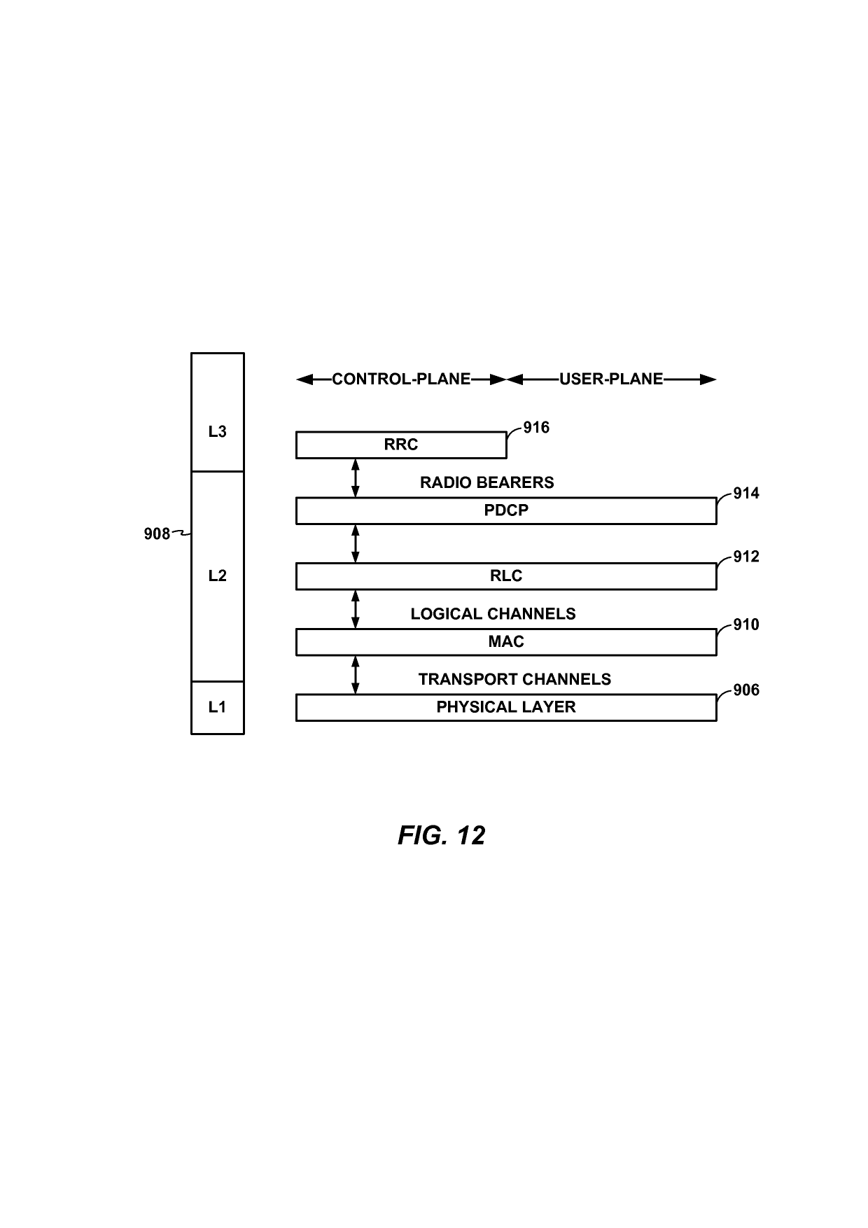

The radio protocol architecture may take on various forms depending on the particular application. An example for an HSPA system will now be presented with reference to FIG. 12. FIG. 12 is a conceptual diagram illustrating an example of the radio protocol architecture for the user and control planes.

Referring to FIG. 12, the radio protocol architecture for the UE and Node B is shown with three layers: Layer 1, Layer 2, and Layer 3. Layer 1 is the lowest lower and implements various physical layer signal processing functions. Layer 1 will be referred to herein as the physical layer 406. Layer 2 (L2 layer) 408 is above the physical layer 406 and is responsible for the link between the UE and Node B over the physical layer 406. For example, the UE and Node B corresponding to the radio protocol architecture of FIG. 12 may be specially programmed or otherwise configured to operate as UE 12 and/or MAC component 16, and/or as network component 14 and/or MAC component 18, as described above.

In the user plane, the L2 layer 408 includes a media access control (MAC) sublayer 410, a radio link control (RLC) sublayer 412, and a packet data convergence protocol (PDCP) 414 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between node Bs. The RLC sublayer 412 provides segmentation and reassembly of upper layer data packets, retransmission of lost data packets, and reordering of data packets to compensate for out-of-order reception due to hybrid automatic repeat request (HARQ). The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

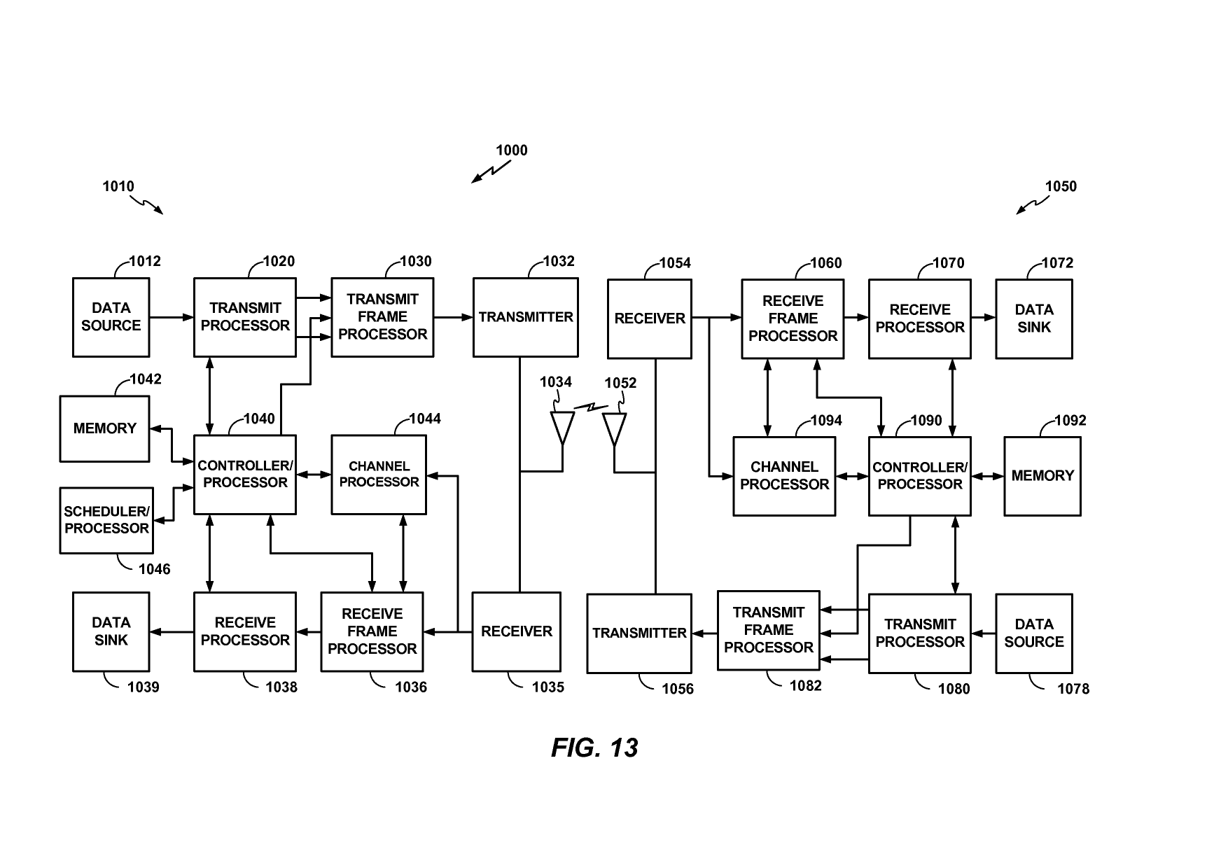

FIG. 13 is a block diagram of a Node B 1010 in communication with a UE 1050. For example, UE 1050 and Node B 1010 respectively may be specially programmed or otherwise configured to operate as UE 12 and/or MAC component 16, and/or as network component 14 and/or MAC component 18, as described above. Further, for example, the Node B 1010 may be the network component 14 in FIGS. 1 and 4, and the UE 1050 may be the UE 12 of FIGS. 1-3. In the downlink communication, a transmit processor 1020 may receive data from a data source 1012 and control signals from a controller/processor 1040. In an aspect, controller/processor 1040 may be configured to implement MAC component 18 of network component 14 of FIGS. 1, 2, and/or 4, and/or any subcomponents therein, and may be configured to as described above. The transmit processor 1020 provides various signal processing functions for the data and control signals, as well as reference signals (e.g., pilot signals). For example, the transmit processor 1020 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1044 may be used by a controller/processor 1040 to determine the coding, modulation, spreading, and/or scrambling schemes for the transmit processor 1020. These channel estimates may be derived from a reference signal transmitted by the UE 1050 or from feedback from the UE 1050. The symbols generated by the transmit processor 1020 are provided to a transmit frame processor 1030 to create a frame structure. The transmit frame processor 1030 creates this frame structure by multiplexing the symbols with information from the controller/processor 1040, resulting in a series of frames. The frames are then provided to a transmitter 1032, which provides various signal conditioning functions including amplifying, filtering, and modulating the frames onto a carrier for downlink transmission over the wireless medium through antenna 1034. The antenna 1034 may include one or more antennas, for example, including beam steering bidirectional adaptive antenna arrays or other similar beam technologies.

At the UE 1050, a receiver 1054 receives the downlink transmission through an antenna 1052 and processes the transmission to recover the information modulated onto the carrier. The information recovered by the receiver 1054 is provided to a receive frame processor 1060, which parses each frame, and provides information from the frames to a channel processor 1094 and the data, control, and reference signals to a receive processor 1070. The receive processor 1070 then performs the inverse of the processing performed by the transmit processor 1020 in the Node B 1010. More specifically, the receive processor 1070 descrambles and despreads the symbols, and then determines the most likely signal constellation points transmitted by the Node B 1010 based on the modulation scheme. These soft decisions may be based on channel estimates computed by the channel processor 1094. The soft decisions are then decoded and deinterleaved to recover the data, control, and reference signals. The CRC codes are then checked to determine whether the frames were successfully decoded. The data carried by the successfully decoded frames will then be provided to a data sink 1072, which represents applications running in the UE 1050 and/or various user interfaces (e.g., display). Control signals carried by successfully decoded frames will be provided to a controller/processor 1090. When frames are unsuccessfully decoded by the receiver processor 1070, the controller/processor 1090 may also use an acknowledgement (ACK) and/or negative acknowledgement (NACK) protocol to support retransmission requests for those frames.

In the uplink, data from a data source 1078 and control signals from the controller/processor 1090 are provided to a transmit processor 1080. The data source 1078 may represent applications running in the UE 1050 and various user interfaces (e.g., keyboard). Similar to the functionality described in connection with the downlink transmission by the Node B 1010, the transmit processor 1080 provides various signal processing functions including CRC codes, coding and interleaving to facilitate FEC, mapping to signal constellations, spreading with OVSFs, and scrambling to produce a series of symbols. Channel estimates, derived by the channel processor 1094 from a reference signal transmitted by the Node B 1010 or from feedback contained in the midamble transmitted by the Node B 1010, may be used to select the appropriate coding, modulation, spreading, and/or scrambling schemes. The symbols produced by the transmit processor 1080 will be provided to a transmit frame processor 1082 to create a frame structure. The transmit frame processor 1082 creates this frame structure by multiplexing the symbols with information from the controller/processor 1090, resulting in a series of frames. The frames are then provided to a transmitter 1056, which provides various signal conditioning functions including amplification, filtering, and modulating the frames onto a carrier for uplink transmission over the wireless medium through the antenna 1052.

The uplink transmission is processed at the Node B 1010 in a manner similar to that described in connection with the receiver function at the UE 1050. A receiver 1035 receives the uplink transmission through the antenna 1034 and processes the transmission to recover the information modulated onto the carrier. The information recovered by the receiver 1035 is provided to a receive frame processor 1036, which parses each frame, and provides information from the frames to the channel processor 1044 and the data, control, and reference signals to a receive processor 1038. The receive processor 1038 performs the inverse of the processing performed by the transmit processor 1080 in the UE 1050. The data and control signals carried by the successfully decoded frames may then be provided to a data sink 1039 and the controller/processor, respectively. If some of the frames were unsuccessfully decoded by the receive processor, the controller/processor 1040 may also use an acknowledgement (ACK) and/or negative acknowledgement (NACK) protocol to support retransmission requests for those frames.

The controller/processors 1040 and 1090 may be used to direct the operation at the Node B 1010 and the UE 1050, respectively. For example, the controller/processors 1040 and 1090 may provide various functions including timing, peripheral interfaces, voltage regulation, power management, and other control functions. The computer readable media of memories 1042 and 1092 may store data and software for the Node B 1010 and the UE 1050, respectively. A scheduler/processor 1046 at the Node B 1010 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Further, unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless transmission by a user equipment (UE), comprising:
determining availability of information for transmission while the UE is in a Cell_FACH state and an idle mode;
generating a message including a scheduling information (SI) indicator during a collision resolution phase of an uplink procedure when SI data is allowed to be transmitted during the collision resolution phase, wherein the SI indicator identifies whether the SI data is included in a Medium Access Control-i (MAC-i) Packet Data Unit (PDU); and
transmitting the message to a network component during the collision resolution phase.

2. The method of claim 1, wherein generating the message including the SI indicator further comprises generating an indicator.

3. The method of claim 2, wherein generating the indicator further comprises generating a spare bit value in a MAC-i header 0 or in a MAC-i header 1.

4. The method of claim 2, wherein generating the indicator further comprises generating a length indicator in a MAC-i header 1.

5. The method of claim 2, wherein generating the indicator further comprises generating a special format of a MAC-i header 0.

6. The method of claim 2, wherein generating the indicator further comprises generating an Enhanced Dedicated Channel (E-DCH) Dedicated Physical Control Channel (E-DPCCH) control information message having a particular re-purposed bit to represent the SI indicator.

7. The method of claim 6, wherein the particular re-purposed bit further comprises one bit of an E-DCH Transport Format Combination Identifier (E-TFCI).

8. The method of claim 1, wherein generating the message including the SI indicator further comprises generating a special MAC-i header positioned in the MAC-i PDU after a Medium Access Control-i (MAC-i) header 0.

9. The method of claim 8, wherein generating the special MAC-i header further comprises generating an additional MAC-i header 0.

10. The method of claim 9, wherein generating the special MAC-i header further comprises generating additional special MAC-i header having a particular bit configuration.

11. The method of claim 10, wherein the particular bit configuration comprises a combination of a reserved Logical Channel Identifier (LCH-ID) value and a particular spare bit value.

12. The method of claim 1, further comprising generating the MAC-i PDU without the SI data, including blocking inclusion of the SI data, where the SI data is prohibited to be transmitted during the collision resolution phase.

13. The method of claim 12, further comprising determining a SI inclusion mode of operation corresponding to a mode prohibiting inclusion of the SI data.

14. The method of claim 1, wherein the SI indicator further identifies a position of the SI data in the MAC-i PDU.

15. A computer-readable medium, comprising:
at least one instruction for causing a computer to determine availability of information for transmission while the UE is in a Cell_FACH state and an idle mode;
at least one instruction for causing the computer to generate a message including a scheduling information (SI) indicator during a collision resolution phase of an uplink procedure when SI data is allowed to be transmitted during the collision resolution phase, wherein the SI indicator identifies whether the SI data is included in a Medium Access Control-i (MAC-i) Packet Data Unit (PDU); and
at least one instruction for causing the computer to transmit the message during the collision resolution phase.

16. A user equipment (UE) apparatus for wireless transmission, comprising:
means for determining availability of information for transmission while the UE is in a Cell_FACH state and an idle mode;
means for generating a message including a scheduling information (SI) indicator during a collision resolution phase of an uplink procedure when SI data is allowed to be transmitted during the collision resolution phase, wherein the SI indicator identifies whether the SI data is included in a Medium Access Control-i (MAC-i) Packet Data Unit (PDU); and
means for transmitting the message during the collision resolution phase.

17. The UE apparatus of claim 16, wherein the means for generating the message including the SI indicator further comprises means for generating an indicator.

18. The UE apparatus of claim 17, wherein the means for generating the indicator further comprises generating a spare bit value in a MAC-i header 0 or in a MAC-i header 1.

19. The UE apparatus of claim 15, wherein the SI indicator further identifies a position of the SI data in the MAC-i PDU.

20. A user equipment (UE) apparatus for wireless transmission, comprising:
at least one processor; and
a memory coupled to the at least one processor, wherein the at least one processor is configured to:
determine availability of information for transmission while the UE is in a Cell_FACH state and an idle mode;
generate a message including a scheduling information (SI) indicator during a collision resolution phase of an uplink procedure when SI data is allowed to be transmitted during the collision resolution phase, wherein the SI indicator identifies whether the SI data is included in a Medium Access Control-i (MAC-i) Packet Data Unit (PDU); and
transmit the message during the collision resolution phase.

21. The UE apparatus of claim 20, wherein the at least one processor is further configured to generate an indicator.

22. The UE apparatus of claim 21, wherein the indicator comprises a spare bit value in a MAC-i header 0 or in a MAC-i header 1.

23. The UE apparatus of claim 1, wherein the SI indicator further identifies a position of the SI data in the MAC-i PDU.

24. A method of wireless communication at a network component, comprising:
identifying a collision resolution phase of an uplink procedure being performed by a user equipment (UE) in a Cell_FACH state and an idle mode when scheduling information (SI) data is allowed to be transmitted during the collision resolution phase;
determining an SI inclusion mode of operation;
receiving, from the UE, a Medium Access Control-i (MAC-i) Packet Data Unit (PDU); and
determining whether the MAC-i PDU includes the SI data based on the SI inclusion mode of operation.

25. The method of claim 24, wherein receiving the MAC-i PDU further comprises receiving an SI indicator, and wherein determining whether the MAC-i PDU includes the SI data is further based on the SI indicator.

26. The method of claim 24, further comprising receiving a message that comprises an SI indicator, and wherein determining whether the MAC-i PDU includes the SI data is further based on the SI indicator.

27. A computer-readable medium, comprising:
at least one instruction for causing a computer to identify a collision resolution phase of an uplink procedure being performed by a user equipment (UE) in a Cell_FACH state and an idle mode when scheduling information (SI) data is allowed to be transmitted during the collision resolution phase;
at least one instruction for causing the computer to determine an SI inclusion mode of operation; and
at least one instruction for causing the computer to determine whether a received Medium Access Control-i (MAC-i) Packet Data Unit (PDU) includes the SI data based on the SI inclusion mode of operation.

28. A network component apparatus for conducting wireless communication, comprising:
means for identifying a collision resolution phase of an uplink procedure being performed by a user equipment (UE) in a Cell_FACH state and an idle mode when scheduling information (SI) data is allowed to be transmitted during the collision resolution phase;
means for determining an SI inclusion mode of operation; and
means for determining whether a received Medium Access Control-i (MAC-i) Packet Data Unit (PDU) includes the SI data based on the SI inclusion mode of operation.

29. The network component apparatus of claim 28, wherein the means for receiving the MAC-i PDU further comprises means for receiving an SI indicator, and wherein determining whether the MAC-i PDU includes the SI data is further based on the SI indicator.

30. The network component apparatus of claim 28, further comprising means for receiving a message that comprises an SI indicator, and wherein determining whether the MAC-i PDU includes the SI data is further based on the SI indicator.

31. A network component apparatus for conducting wireless communication, comprising:
at least one processor; and
a memory coupled to the at least one processor, wherein the at least one processor is configured to:
identify a collision resolution phase of an uplink procedure being performed by a user equipment (UE) in a Cell_FACH state and an idle mode when scheduling information (SI) data is allowed to be transmitted during the collision resolution phase;
determine an SI inclusion mode of operation; and
determine whether a received Medium Access Control-i (MAC-i) Packet Data Unit (PDU) includes the SI data based on the SI inclusion mode of operation.

32. The network component apparatus of claim 31, wherein the at least one processor is configured to receive an SI indicator, and wherein determining whether the MAC-i PDU includes the SI data is further based on the SI indicator.

33. The network component apparatus of claim 31, wherein the at least one processor is configured to receive a message that comprises an SI indicator, and wherein determining whether the MAC-i PDU includes the SI data is further based on the SI indicator.
